(19) United States
(12) Patent Application Publication
(10) Pub. No.: US 2016/0166976 A1
(43) Pub. Date: Jun. 16, 2016

(54) SPLIT LINE SYSTEM, METHOD AND PROCESS FOR CO2 RECOVERY

(71) Applicants: Bumb Prateek, Jaipur (Rajesthan) (IN); CARBON CLEAN SOLUTIONS PVT. LTD, Mumbai (IN)

(72) Inventors: Prateek Bumb, London (GB); Ramesh Kumar Ausula, Banglore (IN); Gopi Kiran Neeliesetty, Nadra Pradesh (IN)

(21) Appl. No.: 14/907,477

(22) PCT Filed: Jul. 23, 2014
(86) PCT No.: PCT/IB2014/002368

§ 371 Date: Jan. 25, 2016

Related U.S. Application Data
(60) Provisional application No. 61/857,288, filed on Jul. 23, 2013.

(51) Int. Cl. B01D 53/14; B01D 53/18

(52) U.S. Cl. CPC B01D 53/1425; B01D 53/1475; B01D 53/1493; B01D 53/18; B01D 2252/604; B01D 2252/602; B01D 2252/20478

(57) ABSTRACT

A process, system or apparatus for recovering C02 from a gas has an absorption section, cooling section, regeneration section and more than three heating sections and involves a split in the C02 rich stream from the first heating section. A solvent for recovering C02 from a gaseous mixture comprising a primary amino hindered alcohol or tertiary amine in combination with a derivative of piperazine with three or more amino groups as promoter and a carbonate buffer is also disclosed.

### CROSS REFERENCE TO RELATED APPLICATION

This application claims the benefit of U.S. Provisional Application No. 61/857,288, filed Jul. 23, 2013, the entire contents of which are incorporated herein by reference.

### TECHNICAL FIELD

This application relates to a CO₂ recovery solvent and heat integrated process unit that can reduce the amount of energy used in regenerating a CO₂ absorbent in a CO₂ recovery process.

### BACKGROUND

Carbon dioxide (CO₂) is a major greenhouse gas responsible for global warming, and hence, much effort is being put on the development of technologies for its capture from process gas streams (e.g., flue gas, natural gas, coke oven gas, refinery off-gas, and bio-gas). Carbon dioxide is emitted in large quantities from large stationary sources. The largest single sources of carbon dioxide are conventional coal-fired power plants. Technology developed for such sources should also be applicable to CO₂ capture from gas and oil fired boilers, combined cycle power plants, coal gasification, and hydrogen plants and bio-gas purification plants. Absorption/stripping is primarily a tail-end technology and is therefore suitable for both existing and new boiler flue gas emissions. The use of absorption and stripping processes for recovery of the carbon dioxide from the gaseous mixture is known in the art.

The conventional carbon capture process consists of an absorber column and a stripper column. Gaseous mixture enters the absorber where it comes in contact with the CO₂ absorbing solvent. The rich stream leaving the absorber has carbon dioxide trapped in solvent composition. The captured CO₂ is stripped in the stripper column with the help of thermal energy provided in the reboiler. The overhead stream from the stripper is condensed and the condensate is passed back to the stripper while the gaseous stream, rich in carbon dioxide is compressed and sent for the suitable applications. The major drawback of conventional carbon capture system is the energy needed to strip the carbon dioxide from the rich solvent.

FIG. 1 shows a conventional CO2 capture system having absorption equipment (101) consisting of, a plurality of inlets (101a) for receiving the gaseous mixture from a gaseous mixture flow line (A) and a solvent composition/solvent from a solvent tank (C); a plurality of reaction chambers (packing column, tray column) provided inside the absorption equipment (101) for facilitating contact between the gaseous mixture and the solvent composition; a plurality of outlets (101b) for passing a treated gaseous mixture to a stack and a rich solvent mixture through a carbon dioxide rich solvent mixture flow line (102). The rich solvent mixture enters the stripper at a predetermined inlet (103a). Outlet (103c) allows for passing the lean solvent composition back to the absorption equipment (101) and the outlet (103d) and for the recovered carbon dioxide to a carbon dioxide flow line (104) respectively. An absorber intercooling (101d) is provided to maintain a lower temperature profile in the absorber (101).

In this system, CO₂ can be removed in the stripper (103) by supplying steam and increasing the temperature of the rich solvent (102). The rich solvent temperature is increased by heating the rich solvent with the lean solvent in the lean/rich exchanger (107). The temperature of the rich solvent to the stripper is limited by the temperature of the lean solvent and the approach to be maintained in the lean rich exchanger. As the mass flow of rich solvent is high compared to lean, the rich solvent temperature is limited by the rich in and lean out temperatures.

In light of foregoing discussion, it is necessary to develop both the improved solvents and heat integrated CO₂ capture processes and systems that can consume less energy for recovering the carbon dioxide from a gaseous mixture.

### SUMMARY

This disclosure includes a process, system or apparatus for recovering CO₂ from a gas contain CO₂ in which an absorption section has (i) an absorption tower having a top portion and a bottom portion and (ii) a liquid feed where the CO₂ containing gas comes in contact with the liquid absorbent feed, a cooling section having where a CO₂ semi rich solution is extracted from the second point downstream of the first point of the absorption cooled using a cooling medium and pumped back to the absorber at a point between the first and second points of the absorption tower; a first heating section; a second heating section where the second portion of CO₂ rich solution gets heated with CO₂ lean solution coming from the regenerator; a third heating section where steam heats the CO₂-rich solution, and/or a fourth heating section where section portion of CO₂-rich solution gets heated with steam condensate. After the first heating section, the CO₂-rich solution slits into a first CO₂ rich solution portion (5-90% of mass flow) that is conveyed to the first point of the regenerator and the second portion of CO₂ rich solution is conveyed to the second heating section.

This disclosure also includes a solvent for recovery of carbon dioxide from gaseous mixture a tertiary amine, cyclic amine promoter or derivative of piperazine with three or more amino groups as a promoter, and a carbonate buffer.

### BRIEF DESCRIPTION OF THE FIGURES

The following specific embodiments of a method, system and apparatus for CO₂ recovery are given as examples only without being limitative in any way, with reference to the accompanying drawings, in which:

FIG. 1 is a schematic of a structure of a conventional CO₂ recovery unit;

FIG. 2 is a schematic of a heat balance of a lean solvent and a rich solvent in a heat exchanger included in the CO₂ recovery unit according to a first embodiment;

FIG. 3 is a schematic of a structure of a CO₂ recovery unit according to a second embodiment;

FIG. 4 is a schematic of a structure of a CO₂ recovery unit according to a third embodiment;

FIG. 5 shows the temperature profiles of a conventional and an exemplary process at the top of the stripper for MEA;

FIG. 6 shows the temperature profiles of a conventional and another exemplary process at the top of the stripper for APBS; and

FIG. 7 shows vapor-liquid equilibrium phase data for various combinations of solvents.

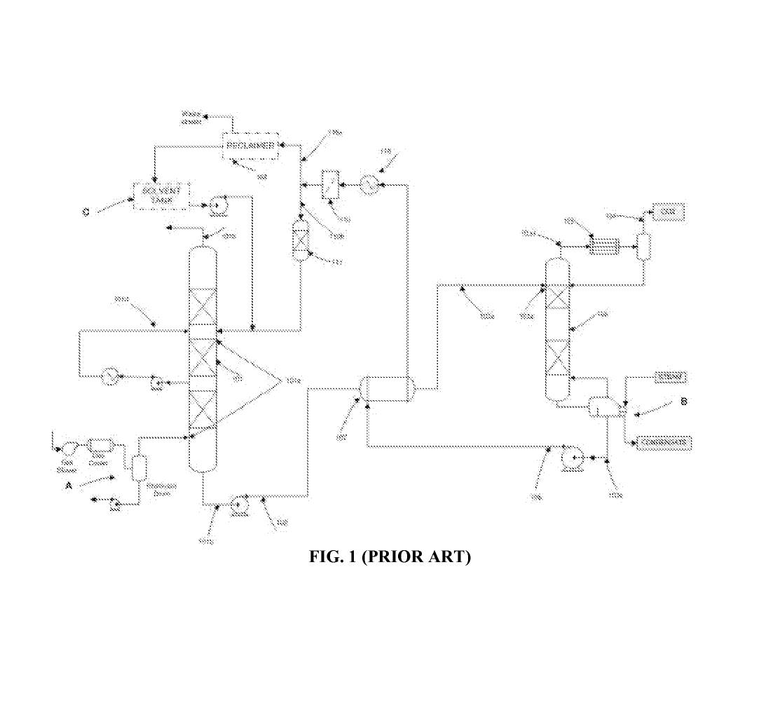

### DETAILED DESCRIPTION

Specific embodiments of a CO₂ recovery system, method, and solvent will now be explained in detail with reference to the drawings. The specific embodiments disclosed herein are not intended to limit the scope of the application in any way.

A first specific embodiment shown in FIG. 2 relates to a system (100) for recovery of carbon dioxide from a gas or gaseous mixture. A gaseous mixture flow line (A) consists of a gas blower, gas cooler, and a knockout drum with a condensate pump for cooling. The CO₂ capture system comprising: an absorption equipment (101) consisting of, a plurality of inlets (101a) for receiving the gaseous mixture from a gaseous mixture flow line (A) and a solvent composition from a solvent tote (C); a plurality of reaction chambers provided inside the absorption equipment (101) for facilitating contact between the gaseous mixture and the solvent composition; a plurality of outlets (101b) for passing a treated gaseous mixture to a stack and a rich solvent mixture through a carbon dioxide rich solvent mixture flow line (102), wherein said carbon dioxide rich solvent mixture flow line (102) is split into two outlets (102a and 102b); at least one stripper (103) for stripping/recovering the carbon dioxide from the rich solvent mixture, said stripper (103) consisting of a pair of inlets (103a and 103b) at predetermined locations connected to the outlets (102a and 102b) of the carbon dioxide rich solvent mixture flow line (102) for receiving the rich solvent mixture; and plurality of outlets (103c and 103d). The figure shows outlet 103c for passing lean solvent composition back to the absorption equipment (101) and the outlet (103d) to recovered carbon dioxide to a carbon dioxide flow line (104) respectively; a heat integrated unique coupling mechanism is provided for preheating the rich solvent mixture before feeding to the stripper (103), wherein said rich solvent mixture (102) is preheated using heat contained in the lean solvent composition coming out of the stripper (103) to achieve a differential temperature profile in the stripper by utilizing the heat of the lean solvent very effectively.

A steam supplier or supplying means (B) or 200 (heating section) is provided for supplying the heat energy to the stripper (103) to strip the carbon dioxide from the rich solvent mixture received from the inlets (103a and 103b). The outlet of the solvent filter (110) is split into two (110a and 110b), and said outlet (110a) is configured to pass through a solvent reclaimer (108) for removing the unrecoverable degraded products from the solvent and recover part of the solvent for reuse in the system, and the outlet (110b) is configured to pass through a carbon bed (111) for removing hydrocarbons, corrosion products, and other solids from the lean solvent. A condenser (109) is provided at the outlet (103d) of the stripper (103) for removing the water present in the recovered carbon dioxide before supplying to the carbon dioxide flow line (104).

The temperature of the rich solvent (102) in the stripper can be increased by utilizing the heat in the lean solvent (103c) more efficiently. The rich solvent (102) is split and higher portion of the rich solvent (102b) is heated using lean solvent (103c) from stripper (103) achieving higher temperature for rich solvent. This rich stream is fed to the lower section of the stripper at the inlet point (103b). The remaining portion of the rich solvent (102a) is fed to the top of the stripper at the inlet point (103a). The embodiment helps in reducing the energy required in the stripper (103) by maintaining a high temperature at the bottom and a low temperature at the top rather than a flat temperature profile as in conventional and other cases.

Another second aspect of this embodiment is to utilize the heat going out of the stripper in the form of high temperature water and CO₂ to the overhead condenser. Hence, line (102a) which is at a low temperature compared to the stripper top temperature is allowed to pass at the top of the stripper and line (102b) is allowed to be heated by lean solvent line (103c) via heat exchanger (105). At the top section, the rich solvent (103a) gets the latent and sensible heats available in the vapor (CO₂+water) going to the top and releases some more CO₂ (104). As per the energy balance around the stripper the heat going out of the stripper in the conventional process is utilized within the stripper. In this manner, a smaller amount of energy is required in the regenerating heater or third heating section (Section B). As a result the amount of steam consumed in the regeneration tower compared with conventional process is reduced by about 20%.

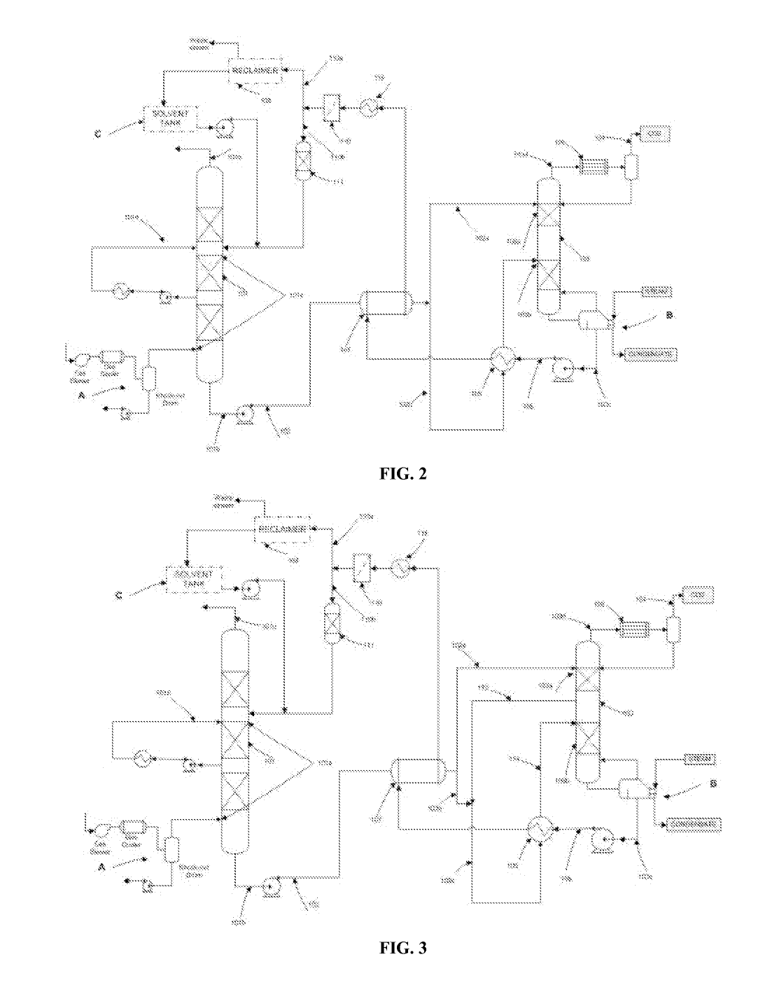

In a second specific embodiment shown in FIG. 3, stream (112) of 5 to 95% (varies) of the flow rate is going to the bottom packing section of the stripper (103) is drawn from a pre determined location in the stripper (103) mixed with the rich solvent split stream (102b) and sent to stripper at a pre determined location (103b). This stream drawn from the stripper (103) is at a higher temperature than the rich solvent going to the heat exchanger (105). This increases the temperature of the stream at the inlet to the exchanger (105) hence higher quantity of the stream can be heated to higher temperature. Effectively the temperature of the liquid taken at a predetermined location of stripper (103) is increased and fed at predetermined location. The lean solvent composition line (106) is configured to pass through a heat exchanger (105, 107) provided in rich solvent mixture flow line (102) for preheating the rich solvent mixture before supplying to the stripper (103).

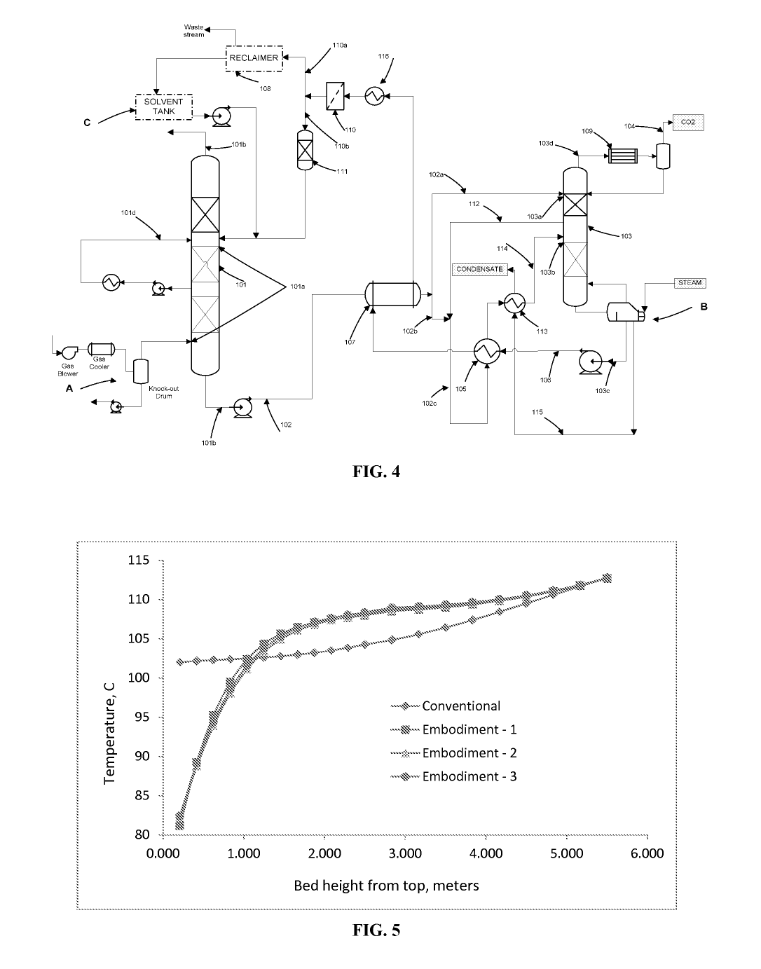

In third specific embodiment shown in FIG. 4, the temperature of stream (114) is increased before entering the stripper (103). This can be achieved by utilizing the thermal energy available in the condensate stream (115). The higher split of rich solvent (102b) after exchanging heat with the lean solvent (106) in heat exchanger (105) gets heated with the steam condensate stream (115) in 113. As shown the system or apparatus for recovering CO₂ from a gas has:
an absorption section comprising (i) an absorption tower having a top portion and a bottom portion (ii) a liquid feed where the gas contacts the liquid absorbent feed from a first portion to form a CO₂-rich solution,
a cooling section where a CO₂ semi-rich solution is extracted downstream of the absorption section using a cooling medium and pumped back to the absorption section between the first point and the second point of the absorption tower,
a regeneration section having a regenerator where the CO2 rich solution is heated utilizing the heat from steam and to produce a CO2 lean solution,
a first heating section (e.g, 107),
a second heating section (e.g., 105) where a portion of CO2 rich solution gets heated with CO2-lean solution coming from regenerator,
a third heating section (e.g., B or 200) where steam is supplied to heat the CO2-rich solution travelled from the regenerator to further remove CO2 and produce a leaner CO2 solution and whereby steam condensate is produced from the steam due to loss of heat from the steam,
a fourth heating section (e.g., 113) where section portion of CO2-rich solution gets heated with the steam condensate from the third heating section, and/or
a first heating section (e.g., 107),

Lean solvent composition line (106) can be configured to pass solvent through a heat exchanger (105, 107) provided in rich solvent mixture flow line (102) for preheating the rich solvent mixture.

The amount of steam used in the regenerating heater is further reduced compared to second embodiment, improving the heat efficiency of the entire system further. As a result the amount of steam consumed in the regeneration tower compared with conventional process is reduced by about 25%.

As can be seen, thiole solvent invention addresses the low CO₂ loading capacity and high energy requirement of the existing carbon dioxide capture solvents. Conventional solvent has several disadvantages with regards to chemical degradation, thermal degradation and corrosivity. These increase the solvent cost and CO₂ recovery cost. The present invention relates generally to solutions for absorbing CO₂ for extraction and purification of gases. More particularly, it relates to a CO₂ absorption solution containing a tertiary amine or primary amino hindered alcohol, a cyclic amine promoter as an activator and carbonate buffer salt to increase CO₂ absorption rate.

Various process steps are described as follow:
Contacting CO₂ with a liquid solvent from an absorption tower, having a top section and an bottom section so to form a CO₂-rich solution, wherein the absorption tower has an absorber,
Cooling the CO₂-rich solution downstream of absorption tower using a cooling medium,
Leaning the CO₂-rich solution by heating the CO2-rich solution in a regenerator using steam, releasing CO₂ upwards, from a third heating section,
Splitting the CO₂-rich solution into a first CO₂-rich solution conveyed to the first point on top section of the regenerator and a second portion of CO₂ rich solution,
Conveying the second CO₂-rich solution to a second heating section wherein the second portion of CO₂-rich solution gets heated with CO₂ lean solution coming from regenerator,
Heating the second CO₂-rich solution in a second heating section consisting of vapor-liquid phase (0-0.05 by volume) and/or
Feeding the second CO₂-rich solution to the regenerator at a second point downstream the splitting step.

An aqueous solution of solvent reacts reversibly with CO₂. Therefore, in chemical industries, for the purpose of removing and recovering general acidic gases, the solvent solution is widely used as the solvent solutions can be regenerated by supplying heat. With respect to the aqueous solution containing a single type of a certain solvent, the absorption capacity performance is not improved proportionally even when the amine concentration is increased. Accordingly, with respect to a certain type of amine, even when the amine concentration of the absorbent liquid is increased, there cannot be obtained an expected effect such that the amount of the absorbent liquid circulated is reduced. Therefore, for reducing the energy for CO₂ recovery, the development of an absorbent liquid, which has an absorption capacity performance and an absorption reaction heat performance dramatically improved, is desired. State of art alkanolamines which are primary and secondary solvent react rapidly with CO₂ to form carbamates. However, the heat of absorption associated with carbamate formation is high. Consequently, this results in high solvent regeneration costs. Further, the CO₂ loading capacity of such alkanolamines solvent is limited to 0.5 mol of CO₂/mol of amine. In particular tertiary amine or hindered amine solvent, which have a low reactivity with respect to CO₂, as in case of MEA and DEA, and thus the carbamation reaction cannot take place. Instead, tertiary amine or primary amino hindered alcohol promote the CO₂ hydrolysis reaction forming bicarbonates. The reaction heat released in bicarbonate formation is lower than that of carbamate formation, thus resulting in lower solvent regeneration costs. Moreover, tertiary primary amino hindered alcohol have a high CO₂ loading capacity of 1 mol of CO₂/mol of amine. In recovering a great amount of CO₂ in a large-scale plant, an apparatus which can recover CO₂ with energy as small as possible is desired. For achieving such an apparatus, an amount of the absorbent liquid circulated and an amount of heat required for desorption of the absorbed CO₂ must be reduced. For reducing the amount of the absorbent liquid circulated, it is necessary to increase the absorption capacity of the absorbent liquid per unit amount of the absorbent liquid, and hence the absorbent liquid frequently has an increased amine compound concentration.

An absorbent that absorbs CO₂ contained in gas, the absorbent comprising two or more amine and carbonate buffer salt compounds selected from tertiary amine or primary amino hindered alcohol and cyclic amine compounds. For improving the CO₂ capture solvent in an absorption performance, the use of a cyclic amine, such as amino ethyl piperazine which enhances the CO₂ absorption rate has been proposed. For reducing the overall vapor pressure of the solvent system and increasing the active amine in the CO₂ capture system carbonate buffer act as a specific role.

An apparatus for removing CO₂ according to the present invention includes an absorption tower that allows gas containing CO₂ and an absorbent liquid to be in contact with each other to remove CO₂ from the gas; and a regeneration tower that regenerates a solution which has absorbed the CO₂, the absorption tower reusing the solution regenerated at the regeneration tower by removing the CO₂ from the solution. The absorbent liquid includes a first component, including tertiary amine which comprises two alkyl replacing the hydrogen atoms of the amino or primary amino hindered alcohol which comprises of hindered group attached with the amine group. Since there is a hydrogen atom attached to the nitrogen atom but due to the hindrance effect around amine group the carbamation reaction cannot take place due to the bulky group. A second component which acts as an activator in an aqueous hindered amine solution enhances the rate of CO₂ absorption. A piperazine derivative with three or more amino groups was selected as an activator.

Hindered amine compounds used as the first component in the present invention include N,N-diethyl ethanolamine (DEEA) or primary amino hindered alcohol as 2-amino-2-methylpropanol (AMP), Wherein the cyclic amine is selected from group comprising N-aminoethylpiperazine (AEP), and potassium carbonate buffer to catalyze the reaction of CO2 with the solvent.

Specific embodiments also include a solvent for recovery of carbon dioxide from gaseous mixture having a primary amino hindered alcohol, a derivative of piperazine with three or more amino groups as promoter, a buffer (e.g., a carbonate buffer). The primary amino hindered alcohol can be 2-amino-2-methylpropanol (AMP) and the carbonate buffer is a potassium carbonate buffer and the promoter can be N aminoethylpiperazine (AEP). A solvent for recovery of carbon dioxide from gaseous mixture also may have a tertiary amine, a derivative of piperazine with three or more amino groups as promoter, and buffer (e.g., a carbonate or potassium carbonate buffer). The solvent can contain less than about 75% by weight of water and has a single liquid phase. In one example, the carbonate buffer is a potassium carbonate buffer and the tertiary amine is N,N-diethyl ethanolamine (DEEA). In another example, the solvent the promoter is N-aminoethylpiperazine (AEP) and the carbonate buffer is potassium carbonate buffer.

### EXAMPLES

The following examples are not intended to limit or depart from the scope and spirit of the disclosure.

### Example 1

### Comparative Example

The energy supplied in the reboiler is mainly contributed towards the heat of desorption (kcal/kg of CO₂ stripped), latent heat of vaporization water (kcal/kg of CO₂ stripper) and sensible heat (entire heat of lean solvent can't be transferred to rich solvent going to stripper) supplied to rich solvent to attain the required temperature of stripper. In the conventional configuration the rich solvent is heated using the lean solvent heat and fed at the top of the stripper. The temperature profile in the stripper is almost flat. The vapor leaving at the top of the stripper is at high temperature (80-100 Deg C) and contains lot of water vapor. This stream cooled in the condenser to remove water and get high concentration of CO₂. And as the temperature of the rich solvent coming to the stripper is also at high temperature there would be further evaporation of water.

As shown herein, the utilization of evaporation energy in the stripper itself in FIG. 2, the rich solvent can be split after the first lean rich exchanger where the temperature is between 50-70 Deg C. One portion of rich solvent 102a is sent to the top of the stripper. This stream being at lower temperature condenses and utilizes the heat of water vapor and CO₂ going to the top of the stripper and gets heated to higher temperature. To achieve the objective of increasing the temperature in the stripper the other rich solvent split 102b (20 to 80%) is heated using the lean solvent from stripper reboiler before fed to the predetermined lower section of the stripper. The rich solvent which is heated in the lean/rich exchanger which is less in quantity take less amount of heat (compared to conventional) but the temperature rise would be significant. This stream which is fed at the second section of the stripper increases the temperature in the bottom section of stripper thus increasing the CO₂ stripping. The present embodiments are simulated using a simulation tool to predict the performances for MEA and APBS solvents. The temperature profiles of the stripper for the conventional and all the three embodiments with rich solvent split are shown in FIG. 5 and FIG. 6 for MEA and APBS solvents respectively

As shown in FIGS. 5 & 6, the temperature profiles of conventional and new process we see that in the new process the temperature at the top of the stripper is less means the water vapor has condensed giving away the heat to rich solvent. This is going to reduce the heat required in the reboiler as we utilized the heat which was going to condenser cooling water in the conventional process.

The optimum rich solvent split depends on characteristics of the solvent. The quantity of rich solvent that shall be sent to top of the stripper depends on the amount of water evaporated in the reboiler. For absorbent solutions with high concentration of water, high heat of absorption and low CO₂ loading capacity (requires high temperature) need higher portion of rich solvent to be routed to top of the stripper.

### Example 2

A study was performed to understand the optimum split of rich solvent for APBS solvent. Because of high CO₂ loading capacity the optimum split required is 15-20% of the rich solvent to the top section of the regenerator as the evaporation of water in the case of APBS is less. For the case MEA solvent the split required is more than 40% because of its low CO₂ loading capacity. Hence, this also significantly reduces the condenser duty as shown in the Table 1.

TABLE 1
Performance summary with different rich solvent split for APBS solvent.

| Parameter | Units | Base | V1 | V2 | V3 | V4 | V5 |
|---|---|---|---|---|---|---|---|
| CO2 in the inlet | kg/hr | 104.5 | 104.5 | 104.5 | 104.5 | 104.5 | 104.5 |
| Rich Solvent Split | % | 0 | 70 | 50 | 30 | 20 | 20 |
| Steam Demand | kg/kg of CO₂ | 1.29 | 1.207 | 1.167 | 1.084 | 1.046 | 1.01 |
| Condenser Duty | kcal/hr | 17288 | 12020 | 9212 | 6357 | 5188 | 4183 |

Along with the rich solvent split if we consider withdrawal of stream from the middle of the stripper and heat it in the lean rich exchanger the temperature can be further increased as explained in the second embodiment section which can reduce the energy requirement further.

### Example 3

The heat from the steam condensate to heat the rich solvent further increases the temperature in the stripper to further reducing the steam requirement.

The energy savings for all the three embodiments for MEA and APBS solvents are as shown in Table 2 and Table 3 respectively.

TABLE 2
Energy savings with the new processes over conventional process for MEA

| | | Conventional | FIG. 2 | FIG. 3 | FIG. 4 |
|---|---|---|---|---|---|
| CO2 concentration in the | vol % | 14.2 | 14.2 | 14.2 | 14.2 |
| inlet | | | | | |
| CO2 in the inlet | kg/hr | 104.55 | 104.55 | 104.55 | 104.55 |
| CO2 recovery | % | 91.13 | 90.87 | 91.13 | 91.02 |
| Steam Demand | kg/kg of CO₂ | 1.868 | 1.526 | 1.522 | 1.471 |
| Reboiler Duty | kcal/kg of CO₂ | 965 | 789 | 786 | 760 |
| Lean Solvent cooler duty | kcal/hr | 39088 | 43117 | 43875 | 42987 |
| Stripper Condenser duty | kcal/hr | 39394 | 17242 | 16480 | 16881 |
| Steam condensate heater | kcal/hr | 0 | 0 | 0 | 2385 |
| Savings over base case | % | 0 | 18.31 | 18.55 | 21.25 |

TABLE 3
Energy savings with the new processes over conventional process for APBS

| | | Conventional | FIG. 2 | FIG. 3 | FIG. 4 |
|---|---|---|---|---|---|
| CO2 concentration in the | vol % | 14.2 | 14.2 | 14.2 | 14.2 |
| inlet | | | | | |
| CO2 in the inlet | kg/hr | 104.55 | 104.55 | 104.55 | 104.55 |
| CO2 recovery | % | 90.27 | 90.08 | 90.07 | 90.09 |
| Steam Demand | kg/kg of CO₂ | 1.29 | 1.01 | 1.00 | 0.96 |
| Reboiler Duty | kcal/kg of CO₂ | 667.99 | 521.28 | 515.84 | 493.74 |
| Lean Solvent cooler duty | kcal/hr | 34980 | 33780 | 33046 | 33299 |
| Stripper Condenser duty | kcal/hr | 17288 | 4302 | 4097.00 | 4183 |
| Steam condensate heater | kcal/hr | | | | 2458 |
| Savings over base case | % | 0 | 21.96 | 22.78 | 26.09 |

### Example 3

The first component is 2-amino-2-methylpropanol (AMP) which is a primary amino alcohol. In the absorbent liquid according to the present invention, the primary amino alcohol may be contained in an amount in a range from equal to or larger than 1M-4 M.

The second compound component is 2-Piperazine-1-ethylamine (AEP) which act as the activator to enhance the CO₂ absorption rate with a unique characteristic of low vapor pressure, high boiling point and special molecule with primary, secondary and tertiary amine promoter in the same compound associated with different pKa in an amount in a range from equal to or larger than 0.5 M-3.5 M. The third compound is carbonate buffer salt in a range from equal to or larger than 0.01 M to 0.8 M.

### Example 4

The first component is N, N-diethyl ethanolamine (DEEA) that is a tertiary amine. In the absorbent liquid according to the present invention, the tertiary amine may be contained in an amount in a range from equal to or larger than 1M-4 M.

The second compound component is 2-Piperazine-1-ethylamine (AEP) which act as the activator to enhance the CO₂ absorption rate with a unique characteristic of low vapor pressure, high boiling point and special molecule with primary, secondary and tertiary amine promoter in the same compound associated with different pKa in an amount in a range from equal to or larger than 0.5 M-3.5 M. The third compound is carbonate buffer salt in a range from equal to or larger than 0.01 M to 0.8 M.

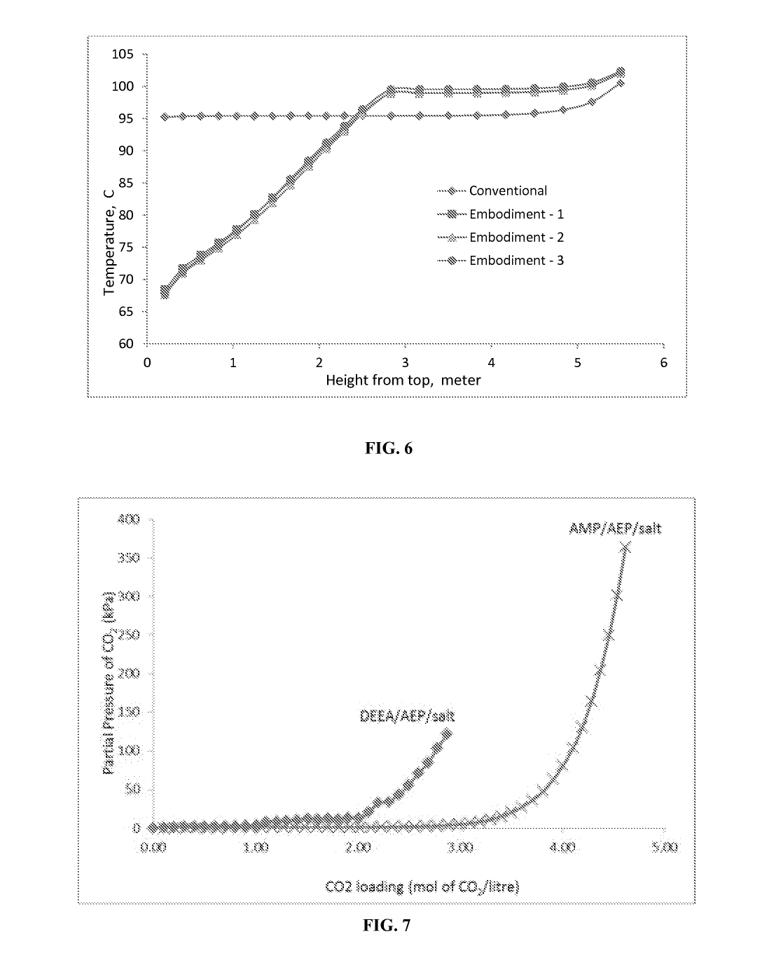

The vapor liquid equilibrium data for few combinations of the first component, activator and buffer salt are shown in FIG. 7 The kinetic rates for absorbents with different concentrations of these components are shown in Table 4 below.

TABLE 4
Rate of reaction of absorbent solutions

| | Partial Pressure | Rate of Reaction * |
|---|---|---|
| | of CO₂ (kPa) | 10⁵ kmol/(m² s) |
| Solvent Concentration | kPa | kmol/(m² s) |
| 3M AMP + 2M AEP + 0.05M | 6.87 | 1.85 |
| SALT | | |
| | 5.40 | 1.25 |
| 3.5M AMP + 0.8M AEP + 0.05M | 27.50 | 2.31 |
| SALT | | |
| 3.5M AMP + 1M AEP + 0.05M | 25.07 | 3.08 |
| SALT | | |
| 3.5M AMP + 1.2M AEP + 0.05M | 17.18 | 2.16 |
| SALT | | |
| | 5.78 | 1.08 |

The above detailed description, the drawings, and the examples, are for illustrative purposes only and are not intended to limit the scope and spirit of the invention, and its equivalents, as defined by the appended claims. One skilled in the art will recognize that many variations can be made to the invention disclosed in this specification without departing from the scope and spirit of the invention.

1. An apparatus for recovering C0₂ from a gas containing C0₂, comprising:
(a) an absorption section comprising (i) an absorption tower having a top portion and a bottom portion (ii) a liquid feed where the gas contacts the liquid fed to form a C0₂-rich solution,
(b) a cooling section where a C0₂ semi-rich solution is extracted downstream of the absorption section using a cooling medium and pumped back to the absorption section between the first point and the second point of the absorption tower,
(c) a regeneration section having a regenerator where the C0₂ rich solution is heated utilizing the heat from steam and to produce a C0₂ lean solution,
(d) a first heating section,
(e) a second heating section where a portion of C0₂ rich solution gets heated with the C02-lean solution coming from the regenerator,
(f) a third heating section where steam is supplied to heat the C02-rich solution traveling from the regenerator to further remove C02 and produce a leaner C02 solution and whereby steam condensate is produced from the steam due to loss of heat from the steam, and
(g) a fourth heating section where a portion of the C02-rich solution gets heated with the steam condensate from the third heating section.

2. An apparatus according to claim 1, wherein the apparatus is structured such that, after the first heating section, the C0₂ rich solution slits into (i) a first C0₂ rich solution (5-90% of mass flow) that is conveyed to a top section of the regenerator and a second C0₂ rich solution that is conveyed to the second heating section, (ii) the second C0₂ rich solution in a vapor-liquid phase by about 0-0.05 by volume is fed to the regenerator downstream of the first heating section.

3. The apparatus according to claim 1, wherein the C0₂ lean solution and the second C0₂ rich solution is conveyed to the second heating section.

4. The apparatus according to claim 1, further comprising a semi C0₂ lean solution conveying path drawn from downstream of the regenerator with 0-80% of the liquid flow and mixed with the second C0₂-rich solution going to the second heating section.

3. (canceled)

5. The apparatus according to claim 1, further comprising a semi C0₂ lean solution conveying path drawn from downstream of the regenerator with 0-80% of the liquid flow and mixing with the second C02-rich solution going to the second heating section at a point after the split.

6. The apparatus according to claim 2, wherein the heat steam condensate from the second heating section conveys the C02 solution into a first heating section and a second heating section.

7. A C0₂ recovery process, comprising:
(a) Contacting a gas having C0₂ with a liquid solvent from an absorption tower, having a top section and an bottom section, to form a Co2-rich solution, wherein the absorption tower has an absorber,
(b) cooling the C0₂-rich solution downstream of absorption tower using a cooling medium,
(c) leaning the C0₂-rich solution by heating the C0₂-rich solution in a regenerator using steam and releasing C0₂ upwards, from a third heating section,
(d) splitting the C0₂-rich solution into a first C0₂-rich solution conveyed to the first point on top section of the regenerator and a second portion of C02 rich solution,
(e) conveying the second C0₂-rich solution to a second heating section wherein the second portion of C0₂-rich solution gets heated with C0₂ lean solution coming from regenerator,
(f) heating the second C0₂-rich solution in a second heating section, wherein the solutions has a vapor-liquid phase (0-0.05 by volume), and
(g) feeding the second C0₂-rich solution to the regenerator at a second point downstream the splitting step (d).

8. The process as claimed in claim 7, pumping the Co2-rich solution to the absorber at a point between first and second points of the absorption tower.

9. The process as claimed in claim 7, further comprising supplying steam in a third heating section to heat the C02-rich solution from the regenerator in remove C02 and produce C02-lean solution, whereby a steam condensate is produced from the steam.

10. The process as claimed in claim 7, further comprising drawing the C02 lean solution from the bottom of regenerator and conveying the C02 lean solution to the second heating section.

11. A solvent for recovery of carbon dioxide from gaseous mixture, comprising:
(a) Primary amino hindered alcohol
(b) Derivative of piperazine with three or more amino groups as promoter
(c) a carbonate buffer,
wherein the solvent contains less than about 75% by weight of water and has a single liquid phase.

12. The solvent as claimed in claim 11, wherein the primary amino hindered alcohol is 2-amino-2-methylpropanol (AMP), wherein the carbonate buffer is a potassium carbonate buffer and the promoter as defined in 8 is N aminoethylpiperazine (AEP),

13. A solvent for recovery of carbon dioxide from gaseous mixture, comprising:
(a) Tertiary amine
(b) Derivative of piperazine with three or more amino groups as promoter
(c) A carbonate buffer,
wherein the solvent contains less than about 75% by weight of water and has a single liquid phase, the carbonate buffer is a potassium carbonate buffer, the tertiary amine compounds used in the present invention is N,N-diethyl ethanolamine (DEEA),

14. The solvent as claimed in claim 13, wherein the promoter as defined in claim 10b is N-aminoethylpiperazine (AEP) and a carbonate buffer is potassium carbonate buffer.

15. An system for recovering C0₂ from a gas containing C02, comprising:
(a) an absorption section comprising (i) an absorption tower having a top portion and a bottom portion (ii) a liquid feed where the gas comes in contact with the liquid absorbent fed from the first portion to form a C0₂-rich solution,
(b) a cooling section where a C0₂ semi-rich solution is extracted downstream of the absorption section using a cooling medium and pumped back to the absorption section between the first point and the second point of the absorption tower,
(c) a regeneration section having a regenerator where the C0₂ rich solution is heated utilizing the heat from steam and to produce a C0₂ lean solution,
(d) a first heating section,
(e) a second heating section where a portion of C0₂ rich solution gets heated with C02-lean solution coming from regenerator,
(f) a third heating section where steam is supplied to heat the C0₂-rich solution travelled from the regenerator to further remove C0₂ and produce a leaner C02solution and whereby steam condensate is produced from the steam due to loss of heat from the steam, and
(g) a fourth heating section where section portion of C0₂-rich solution gets heated with the steam condensate from the third heating section.

16. The apparatus according to claim 2, wherein the apparatus is arranged to the heat steam condensate from the second heating section before splitting the C02 solution into the first and the second C02-rich solutions.
